(19) United States
(12) Patent Application Publication
(10) Pub. No.: US 2001/0027404 A1
(43) Pub. Date: Oct. 4, 2001

(54) Integrated learning objects

(76) Inventor: James B. Loveland, Orem, UT (US)

Correspondence Address: Michael F. Krieger, Kirton & McConkie, 1800 Eagle Gate Tower, 60 East South Temple, Salt Lake City, UT, 84111, US

(21) Appl. No.: 09/750,520

(22) Filed: Dec. 28, 2000

Related U.S. Application Data
(60) Provisional application No. 60/174,095, filed on Dec. 31, 1999.

(51) Int. Cl. G06F 17/60

(52) U.S. Cl. 705/7; 705/26

(57) ABSTRACT

The present invention relates to methods and apparatus for providing integrated instruction, estimating and purchasing for a task or group of tasks. Methods and apparatus of the present invention accomplish this integration through the use of a computer network which may provide access to multiple users. Some embodiments of the present invention comprise a network site or Internet site which provides interactive instruction regarding a task to be accomplished. Once the user has completed the instruction module, he or she may access an estimating module to obtain estimates of the cost of purchasing the materials or services required for the task. When the user has made a purchase decision based on the estimates, the user may proceed to a purchasing module which allows the purchaser to order the materials or services required for the task. The above methods may be applied to almost any task, including, but not limited to, building construction and remodeling, vehicle maintenance, computer maintenance and modification as well as many others.

### RELATED APPLICATIONS

This application claims priority to provisional application Ser. No. 60/174,095, filed Dec. 31, 1999.

### THE FIELD OF THE INVENTION

The present invention relates to methods and apparatus for providing integrated instruction, estimating, and purchasing for a task or group of tasks. Methods and apparatus of the present invention accomplish this integration through the use of a computer network which may provide access to multiple users. Some embodiments of the present invention comprise a network site or Internet site which provides interactive instruction regarding a task to be accomplished. Once the user has completed the instruction module, he or she may access an estimating module to obtain estimates of the cost of purchasing the materials required for the task. Several estimates may be obtained from various sources. Estimates may also be obtained for having a professional complete the task wherein the user may compare the relative costs of these options. When the user has decided which option to pursue, the user may proceed to a purchasing module which allows the purchaser to order the materials or services required for the task. The above methods may be applied to almost any task, including, but not limited to, building construction and remodeling, vehicle maintenance, computer maintenance and modification, and others.

### BACKGROUND

Many individuals have embraced the do-it-yourself philosophy in maintaining and operating their assets with an eye toward economy. This philosophy can apply to many areas of building construction and maintenance, vehicle maintenance, computer and appliance maintenance and installation. With the high labor costs involved in these areas, do-it-yourself maintenance can realize significant economic savings for an owner.

One hurdle that must be overcome in this process is the initial training required to accomplish a task. When one has never performed a task or seen a task performed, it is difficult to achieve the required familiarity to accomplish the task without specialized training. This is true even for simple tasks that can be learned through basic instruction techniques. Often, with nominal training, the average person can accomplish a myriad of tasks that are typically performed only by professionals.

Another obstacle in performing an unfamiliar task is becoming familiar with the jargon used to describe the apparatus upon which the task must be performed. Specialized tools and parts must often be ordered with extreme specificity or the task cannot be completed. Disassembling an appliance only to find out the wrong part has been ordered can be extremely frustrating and will often incur additional time and expense to complete the task. Proper training can go a long way to avoid this situation.

Once an individual is trained in performing a task, they must obtain the parts and tools required to accomplish it. Replacing a clutch in a vehicle, connecting an Ultra DMA hard drive to a motherboard-integrated controller and installing a dishwasher all require specialized tools or parts not found in the average person's closet or garage. These parts and tools can be purchased or rented for completion of a task when the user is aware of the need in advance.

When parts and tools are identified, their costs must be obtained so that the potential do-it-yourselfer can make an assessment of economic viability. Typically this involves visiting or calling several retailers who stock the items. This can be a frustrating and time-consuming process as many retailers will carry only a portion of the items needed.

After the cost of the parts and tools is calculated, an individual may want to compare this cost with the cost of having a professional perform the task entirely. Again, this can be very time consuming as one attempts to contact and obtain estimates from professionals who may be scarcely available, difficult to contact or unreliable.

With relative costs in hand and a decision as to the method of task completion, the taskmaster is now ready to order the supplies or services required for the task. This can involve several trips to several suppliers and waiting periods as back-ordered supplies come into the suppliers stores. If a professional has been selected, a significant waiting period may be experienced as he or she becomes available.

### SUMMARY AND OBJECTS OF THE INVENTION

The present invention features an integrated computerized system for preparing for the accomplishment of a task. The system comprises: 1) a training module capable of providing interactive training to a user regarding how to perform the task; 2) an estimating module capable of estimating the cost of materials required for the task; and 3) a purchasing module capable of providing means for purchasing the materials.

The present invention further features a method for preparing to accomplish a task. The method comprises the steps of: 1) generating user input on a computer, wherein the information entered pertains to the task; 2) training a user regarding how to perform the task, where the information input by the user is utilized; 2) estimating the cost of materials required for the task; and 3) purchasing the required materials if so desired.

Some embodiments of the present invention provide an integrated source for training and education regarding a task, estimating the cost of completing the task, and purchasing the materials or services required for the task.

Embodiments of the present invention may be implemented as a network site or an Internet site which can be accessed by multiple users from many locations. A series of linked and integrated sites may also be implemented. As such the present invention also features a computer-readable memory for accomplishing a task where the computer-readable memory is configured so that it can be used to direct a computer to gather and store information pertaining to at least one task; to provide a training module designed to train a user regarding how to perform the task; to provide an estimating module designed to estimate the cost of materials required for the task; to provide a purchasing module designed to facilitate purchasing the materials; to access and retrieve the information pertaining to the at least one task; and to present the information pertaining to the at least one task to a graphical user interface.

In addition, a computer-readable data transmission signal containing a data structure is also included in the present invention. This is to enable client and network communication to carry out the objects and advantages of the present invention.

Embodiments of the present invention comprise a training or education module for training a user on how to complete a task. Generally, this will involve a training session which may include audio, video, and/or text-based learning. This may be an interactive module with testing and evaluation of user skills. During this training, a user will be taught the procedure for accomplishing a specific task. This may include the use of any specialized tools and the descriptions of any specialized parts or components that will be needed. Once the user is confident in his or her skills, he or she may proceed to an integrated estimating module to evaluate the costs involved with the task.

Embodiments of the present invention also comprise an estimating module which provides a user with an estimate of the cost of obtaining the supplies or services required to complete a specific task. A user may assemble or compile a task-specific database including information regarding supplies and materials based on knowledge obtained in a training session. In addition, the task-specific database may be generated automatically by embodiments of the present invention based on the user's selection of the task to be performed or other input from a user. Regardless of the manual or automatic generation of the task-specific database, the cost of the materials is provided to a user. This cost may be supplied directly through display on the network site or may be provided by e-mail or other means. Costs provided by embodiments of the present invention may comprise the actual purchase prices of items or services, estimates of the actual costs based on average regional values, or other cost estimation methods. Estimates may be provided for obtaining the materials required to complete a task or for professional services to achieve the same task. Armed with these cost estimates, a user can make an informed decision as to how to accomplish a task and is now ready to order the materials or services required.

Embodiments of the present invention further comprise a purchasing module which allows users to place orders for materials or services. Users may place an order based on the compiled task specific information data base previously generated in the training and estimating modules or may update or modify the compiled task-specific information as needed. Vendors may be directed to deliver the materials or services directly to the user.

Embodiments of the present invention integrate the above modules to provide convenience to the user. Information regarding materials or services, as well as the amount of training received by a user as compiled in the task specific information data base, may be transferred between modules to minimize or eliminate repetitious user input and to speed product use. Seamless transitions between modules provide a pleasant and rewarding learning experience and allow a user to accomplish a task without the frustration and delay of present methods.

Accordingly, it is an object of some embodiments of the present invention to provide a system for training and educating a user about how to accomplish a task.

It is also an object of some embodiments of the present invention to provide a system for estimating the cost of materials and/or services required to accomplish a task.

Another object of some embodiments of the present invention is to provide a system for ordering the materials or services required to accomplish a task.

These and other objects and features of the present invention will become more fully apparent from the following, description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts the task preparation system in accordance with the present invention.

FIG. 2 depicts the training module and associated information components in accordance with the present invention.

FIG. 3 depicts the estimation module and associated information components in accordance with the present invention.

FIG. 4 depicts the purchasing module and the various purchasing options in accordance with the present invention.

FIG. 5 depicts the inter relation between the training, estimation, and purchasing modules in accordance with the present invention.

### DETAILED DESCRIPTION OF THE PREFERRED EMBODIMENTS

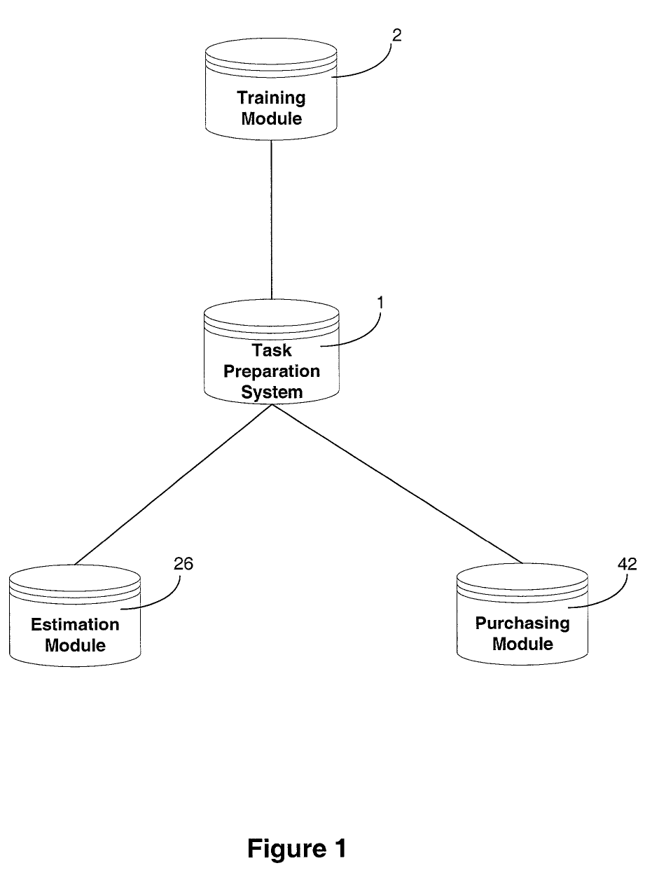

Shown in FIG. 1 is the task preparation system 1 designed to facilitate the accomplishment of a task according to the present invention. The system is comprised of training module 2, estimation module 26, and purchasing module 42. Each of these modules interact in a manner so as to provide the user with the most efficient manner in which to complete the task. A task is defined herein as any project or undertaking that may be accomplished by an individual. Typically, tasks will include the building of structures or things, repairs, how-to projects, etc.

Preferred embodiments of the present invention feature integrated sources for training and education regarding a task, estimating the cost of materials and services required to complete the task, and purchasing the materials or services required for the task.

Embodiments of the present invention may be implemented as a network site or Internet site, which can be accessed by multiple users from many locations. As such, the present invention also features a computer-readable memory for accomplishing a task where the computer-readable memory is configured so that it can be used to direct a computer to train a user regarding how to perform the task; to estimate the cost of materials required for the task; and to provide a method of purchasing the materials required to complete the task.

In addition, a computer-readable data transmission signal containing a data structure is also included in the present invention. The computer-readable data transmission signal comprises 1) a first portion identifying a task-specific training module that a client is requesting from a server, wherein the client may receive interactive training and education regarding a task; 2) a second portion identifying an estimating module, wherein the client may compile information relating to a cost associated with the task; and 3) a third portion identifying a purchasing module, wherein the client may purchase any needed materials to complete the task. The training module, the estimating module, and the purchasing module each allowing communication between the client and the server.

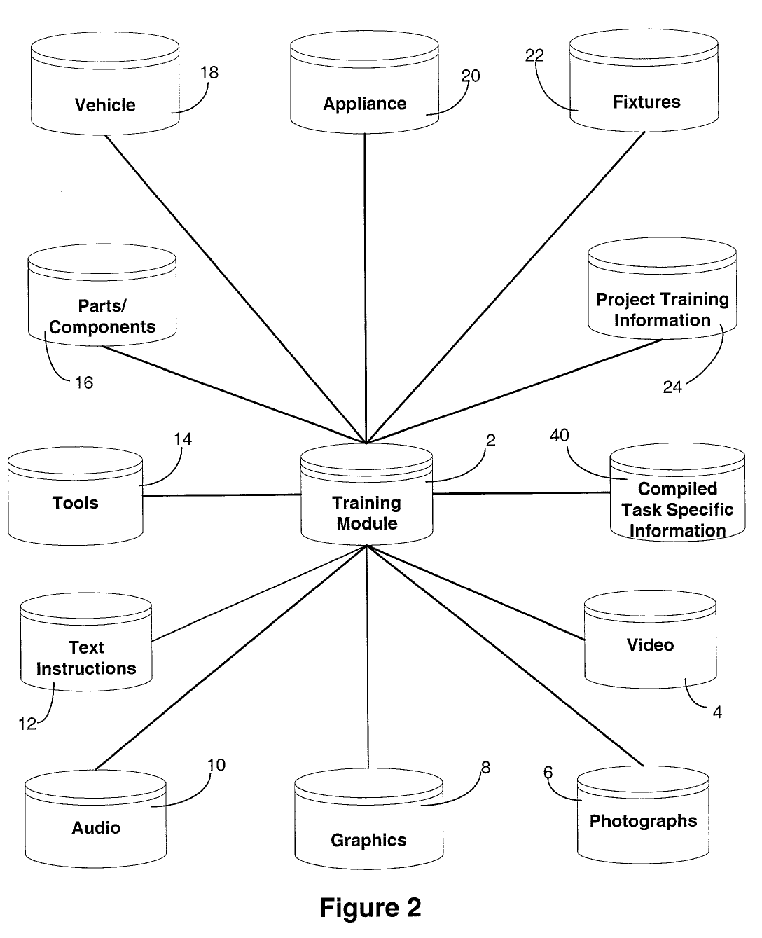

As shown in FIG. 2, the preferred embodiment of the present invention comprises a training or education module 2 for training a user on how to complete a task. Training module 2 may use a lesson presented by various means including streaming video 4, digitized photographs 6, animated graphics 8, audio recordings 10, text 12, or other methods to instruct a user regarding the steps necessary to complete a task. Some lessons will be interactive allowing the user to request a more detailed explanation of specific steps of the task. Other training methods may include on-line chat sessions with professionals and skilled instructors and testing and other evaluation of user skills to increase user confidence and knowledge.

Once training module 2 is initiated, a user will be taught the procedure for accomplishing a specific task. A database of project training information 24 may include information on the use of any specialized tools 14, and the descriptions of any specialized parts or components 16 that will be needed to complete the task along with any other relevant information. Project information 24 may also include user-generated input that may include specific details of the task he/she is trying to accomplish. All this information may be assembled and compiled into a complete task information data base 40 containing needed materials and/or services, including tools and hardware, to be used in the completion of the task. Task information database 40 is subsequently utilized in both the estimation and purchasing modules to aid the user in determining whether a task would be economically viable in completing himself/herself, rather than seeking the services of a professional. The user may, by way of example, input the make and model of vehicle 18, brand of appliance 20, or size of plumbing fixture 22 may be input to avoid misinterpretation of the task and mistakes in the materials database. As stated, these are only examples. Other databases containing information about various tasks may be added to the system.

Initial input may activate additional prompting for more specific details in an interactive input process. For example, and not by way of limitation, a user indicates that a P-trap must be replaced for a bathroom sink. The system queries the user whether the existing P-trap is a 1 1/2″ or 1¼″ model and whether the user prefers chrome, PVC plastic, or ABS plastic. The system may also use building code information and user location to predict what materials will comply with the local building codes. Likewise, vehicle and appliance manufacturer's recommendations may be incorporated into the system to offer the user materials that are compliant with these recommendations or requirements.

Based on user input and combined with information pre-existing in the system, the user will be able to compile the task-specific database 40 of needed supplies, tools and other materials required to complete the task. This task specific database 40 may be transferred to other system modules for further estimating, evaluation, and purchase. A user may edit task specific database 40 to account for previously purchased materials, presently owned tools, and other factors.

Once the user is confident in his or her skills, he or she may proceed to an integrated estimating module to evaluate the costs involved with the task.

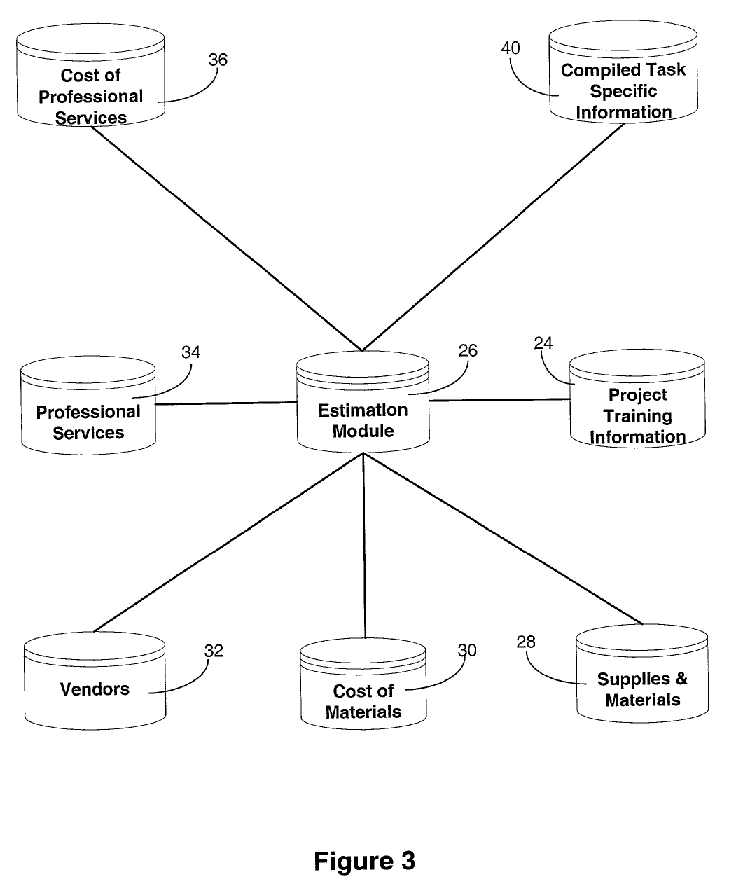

Shown in FIG. 3 is estimation module 26 according to the present invention. In a preferred embodiment of the present invention, estimating module 26 provides a user with an estimate of the cost of obtaining the supplies or services required to complete a specific task. A user utilizes the assembled or compiled task specific database 40, which may further be updated to include information on supplies and materials 28 based on knowledge obtained in a training session, or task specific database 40 may be generated automatically by embodiments of the present invention based on the user's selection of the task to be performed or other input from a user.

Regardless of the manual or automatic generation of task specific database 40, the cost 30 of the materials is provided to a user through estimation module 26. Cost 30 maybe supplied directly through display to the user or may be provided by e-mail or other means. Costs 30 provided by embodiments of the present invention may comprise the actual purchase prices of items or services, estimates of the actual costs based on average regional values, or other cost estimation methods.

Estimating module 26 of the preferred embodiment of the present invention may be linked to vendor databases 32 maintained by vendors or may be linked to a proprietary system. Estimates may be provided for obtaining the materials required to complete a task or for professional services 34 to achieve the same task. In a preferred embodiment, a user is able to make a side-by-side comparison of the cost of obtaining the materials and the cost of a professional 36. With this comparison, a user can evaluate whether the savings incurred by performing a task are sufficient to justify foregoing a professional's performance.

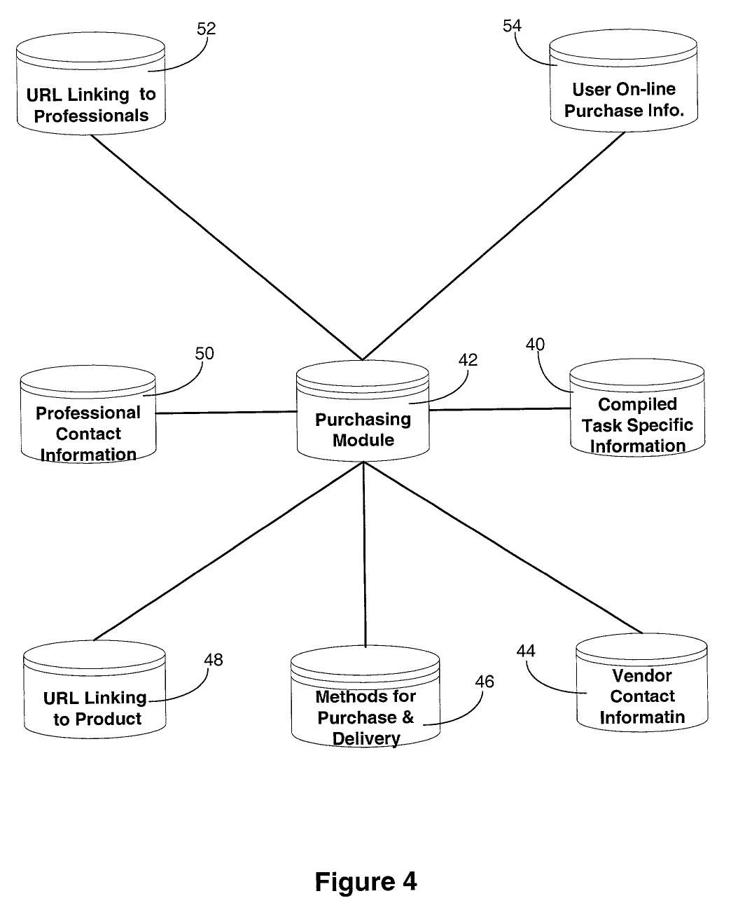

As shown in FIG. 4, the preferred embodiment of the present invention further comprises a purchasing module 42, which allows users to purchase materials using various means, such as online services or traditional brick and mortar methods, and is based upon task-specific database 40. A user may inquire about and obtain vendor contact information 44 including different retailers or distributors who may be able to provide the materials, tools, etc. needed to complete the task. Information regarding the methods for purchase and delivery 46 may also be obtained. Users may place an order based on the information previously generated in the training and estimating modules or may update or modify task specific database 40 as needed. In some embodiments, prices from several vendors may be compared in the estimation module or in the purchase module. Some embodiments also allow the user to select vendors by geographical area and allow the user to choose local vendors from which the user may purchase products by visiting their retail store. Alternatively, the user may order products on-line and have the materials or other items delivered via mail or other delivery methods.

When the retailer has an on-line retail site, the user may be directed to the site to purchase the materials through a link 52 to that professional's web site. When this is done, task-specific data base 40 may be transferred to the retailer's site where the items or products 48 may be directly linked to and compiled for purchase without sifting through the entire selection at the retailer's site. This linking and transfer can significantly speed the purchase process.

A user may, alternatively, select to have a professional perform the task. When this is the case, the user may access contact information 50 enabling the user to contact the professional directly. A user may also contact a professional directly from the system of embodiments of the present invention by linking to a professional's site, e-mailing the professional, accessing a professional's on-line scheduling system or other contact methods.

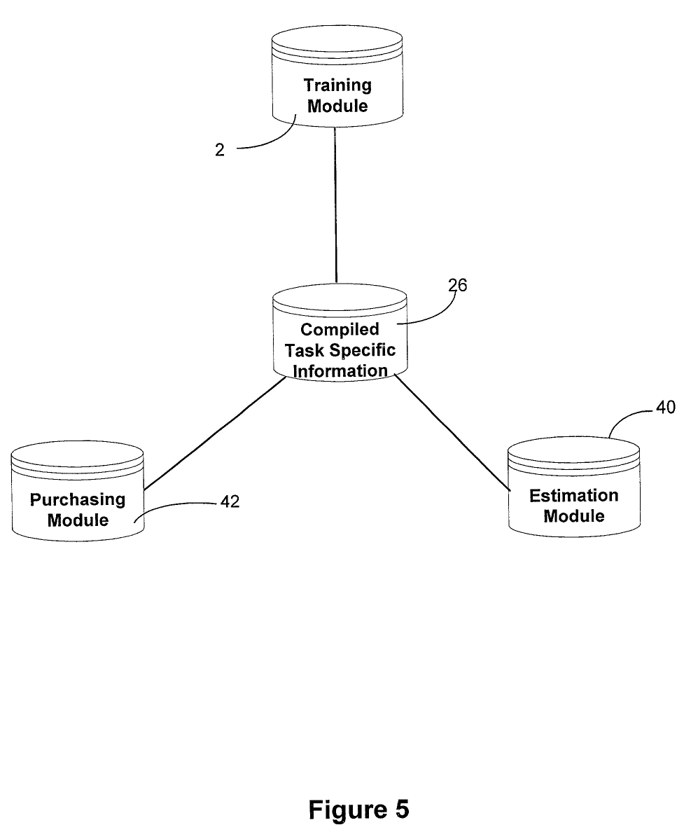

FIG. 5 shows how the training, estimation, and purchasing modules combine to form the present invention. As shown, the user may toggle back and forth between modules to compile the most accurate task-specific database possible.

Savings in time and money are easily realized through the integrated combination of learning, estimation, and purchase provided by preferred embodiments of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. An integrated computerized system for preparing for the accomplishment of a task, said system comprising:
a training module capable of providing interactive training to a user regarding how to perform said task;
an estimating module capable of estimating the cost of materials required for said task; and
a purchasing module capable of providing means for purchasing said materials.

2. The system of claim 1, wherein said training comprises on-line multimedia exercises.

3. The system of claim 1, wherein said user may input information relating to said task, said information to be used in said estimating module.

4. The system of claim 1, wherein said training module allows said user to compile and edit a task specific database of materials and supplies required to perform said task.

5. The system of claim 4, wherein said task specific database is transferred to said estimating and said purchasing modules.

6. The system of claim 1, wherein said estimating module allows said user to estimate the cost of obtaining said materials and said supplies required to perform said task.

7. The system of claim 6, wherein said estimating module allows said user to estimate the cost of professional services to accomplish said task.

8. The system of claim 7, wherein said user may compare said cost of professional services to said cost of obtaining said material and said supplies to evaluate whether any savings incurred by performing said task are justified.

9. The system of claim 1, wherein said purchasing module comprises an on-line link to at least one retailer who can provide said materials.

10. The system of claim 1, wherein said user may select geographic vendors.

11. The system of claim 1, wherein said user may purchase said materials online.

12. The system of claim 1, wherein said purchasing module allows a user to contact a professional to perform said task.

13. The system of claim 1, wherein said system is implemented as an integrated Internet site.

14. A method of preparing for the accomplishment of a task, said method comprising the steps of:
generating user input on a computer, said user input including information pertaining to said task;
training a user regarding how to perform said task, said training utilizing said user input;
estimating the cost of materials required for said task; and
purchasing said materials.

15. The method of claim 14, wherein said step of training is interactive.

16. The method of claim 14, wherein said method comprises on-line multimedia exercises.

17. The method of claim 14, wherein said step of training utilizes a training module.

18. The method of claim 17, wherein said training module allows said user to compile and edit a task specific database of materials and supplies required to perform said task, said task specific database is updated and utilized in said step of estimating and said step of purchasing.

19. The method of claim 18, wherein said step of estimating utilizes an estimating module.

20. The system of claim 19, wherein said task specific database is transferred to said estimating module.

21. The method of claim 19, wherein said estimating module allows said user to estimate the cost of obtaining said materials and said supplies required to perform said task.

22. The method of claim 21, wherein said estimating module allows said user to estimate the cost of professional services to accomplish said task.

23. The method of claim 22, wherein said user may compare said cost of professional services to said cost of obtaining said material and said supplies to evaluate whether any savings incurred by performing said task are justified.

24. The method of claim 14, wherein said step of purchasing utilizes a purchasing module allowing means for purchasing said materials needed for said task.

25. The method of claim 24, wherein said purchasing module comprises an on-line link to at least one retailer who can provide said materials.

26. The system of claim 25, wherein said user may select geographic retailers.

27. The system of claim 26, wherein said means for purchasing allows a user to purchase said materials online.

28. The system of claim 14, wherein said purchasing module allows a user to contact a professional to perform said task.

29. The method of claim 14, wherein said method is implemented as an integrated, interactive Internet site.

30. A computer-readable memory for prepare for the accomplishment of a task, said computer-readable memory configured so that it can be used to direct a computer:
to gather and store information pertaining to at least one task;
to provide a training module designed to train a user regarding how to perform said task;
to provide an estimating module designed to estimate the cost of materials required for said task;
to provide a purchasing module designed to facilitate the purchasing said materials;
to access and retrieve said information pertaining to said at least one task; and
to present said information pertaining to said at least one task to a graphical user interface.

31. A computer-readable data transmission signal containing a data structure, said computer-readable data transmission signal comprising:
a first portion identifying a task-specific training module that a client is requesting from a server, wherein said client may receive interactive training and education regarding a task;
a second portion identifying an estimating module, wherein said client may compile information relating to a cost associated with said task; and
a third portion identifying a purchasing module, wherein said client may purchase any needed materials to complete said task;
said training module, said estimating module, and said purchasing module each allowing communication between said client and said server.

32. The computer-readable data transmission signal of claim 31, wherein said signal propagates across a network.

33. The computer-readable data transmission signal of claim 32, wherein said network is a global information network.
